(19) United States
(12) Patent Application Publication
(10) Pub. No.: US 2006/0188847 A1
(43) Pub. Date: Aug. 24, 2006

(54) Dental rescue implant

(76) Inventors: Kwang Bum Park, Daeku (KR); Seok Kyu Choi, Pusan (KR)

Correspondence Address: MCCARTER & ENGLISH, LLP, FOUR GATEWAY CENTER, 100 MULBERRY STREET, NEWARK, NJ, 07102, US

(21) Appl. No.: 11/344,427

(22) Filed: Jan. 31, 2006

(30) Foreign Application Priority Data
Jan. 31, 2005 (KR) 10-2005-0008468

(51) Int. Cl. A61C 8/00

(52) U.S. Cl. 433/174

(57) ABSTRACT

Disclosed herein is a dental rescue implant implanted into an alveolar bone for forming a root of an artificial tooth. The dental rescue implant includes: a wide sectional body part having a sectional diameter of 6.5 mm to 8 mm, greater than a sectional diameter of 6 mm of a typical implant body part, whereby the wide sectional body part can be implanted directly into the corresponding alveolar bone without refilling a damaged part with a bone substitutive material when implant surgery ends in failure; and a wide screw thread formed on the outer periphery of the wide sectional body part, the wide screw thread being formed at 1˜1.75 pitch intervals, whereby the wide sectional body part is implanted into the alveolar bone with relatively small resistance. The implant can be directly implanted into the alveolar bone without refilling a damaged part with a substitutive material even though a molar teeth part is lost or implant surgery ends in a failure by complex factors.

### CROSS-REFERENCE TO RELATED APPLICATION

This application claims the priority of Korean Patent Application No. 10-2005-0008468 filed Jan. 31, 2005, the disclosure of which is incorporated herein by reference in its entirety for all purposes.

### BACKGROUND OF THE INVENTION

1. Field of the Invention

The present invention relates to a dental rescue implant, and more particularly, to a dental rescue implant which can be directly implanted into an alveolar bone without refilling a damaged part with a substitutive material even though a molar teeth part is lost or implant surgery ends in a failure by complex factors.

2. Background Art

In general, implant means a substitute for recovering a lost or damaged human tissue when the human tissue is lost or damaged, but means transplantation of an artificial tooth in the dental surgery. The implant is the latest technology for recovering functions of teeth by fixing the artificial tooth after an artificial root, which is made of titanium and does not cause rejection to a human body, is implanted into a bone where the real tooth came out, in stead of a real root of a lost tooth. Prostheses or false teeth damage other teeth and bones around the prostheses or the false teeth as time goes by, but the implant can be used semi-permanently since it does not damage teeth tissues around the implant, has the same functions and shape as natural teeth, and does not cause decay of teeth.

A surgical operation process of the artificial tooth includes the steps of implanting an implant into an alveolar bone for osteo-integration, joining an abutment to the implant, and covering the abutment with the final prosthesis. Such implant not only recovers a single lost tooth but also promotes functions of dentures applied to a partially or completely missing teeth patient, provides an improved beautiful outward appearance in substitution and recovery of the teeth, disperses excessive stress applied to the bone around the implant, and is of help to stabilization of a set of teeth.

The implant surgery may end in failure due to various unexpected reasons since success or failure of the implant surgery depends on various complex factors such as biocompatibility, quantity and quality of bone tissues, surgical procedure, and a design of a structure coupled to the upper portion of the implant.

Generally, if a molar teeth part is lost or the implant surgery ends in a failure, an artificial bone substitute material including calcium and phosphorus ingredients which are similar with ingredients of the bone tissue is transplanted for a predetermined time period in order to restore the damaged bone tissue. After that, when the damaged bone tissue is completely restored, an implant of the same size as the previously implanted implant is generally implanted into the alveolar bone.

However, in the case where the implant is re-implanted, there are several problems as follows. Since the time period for restoring the damaged bone tissue is added to the entire implant surgery time, it is difficult to operate urgent surgery due to an increase of a surgical operation time period, and the user and patient feel inconvenience and a pain due to the increase of the surgical operation time period.

Furthermore, the typical implant is divided into a small size, a standard size and a large size according to an implantation place, but most of the implants are manufactured according to Westerners' jawbone structure. In spite of the large-sized implant, most of the implants are less than 6 mm in sectional diameter of a body part. U.S. Pat. No. 5,702,346 discloses such implant.

Finally, in spite of the large-sized implant, it is difficult to avoid re-operation if a predetermined time period passes after the implant is implanted since the sectional diameter (less than 6 mm) of the body part is small. It causes an increase of surgical operation fees, the user's inconvenience, the patient's anxiety about surgical operation, and lowers reliability.

### SUMMARY OF THE INVENTION

Accordingly, to solve the above disadvantages of the prior art, it is an object of the present invention to provide a dental rescue implant, which can be directly implanted into an alveolar bone without refilling a damaged part with a substitutive material even though a molar teeth part is lost or implant surgery ends in a failure by complex factors, thereby greatly reducing a surgical operation time period and enabling urgent surgery.

It is another object of the present invention to provide a dental rescue implant, which can reduce a surgical operation time period, and minimize a re-operation rate by giving a precise and stable surgical operation.

To accomplish the above objects, according to the present invention, there is provided a dental rescue implant implanted into the alveolar bone for forming a root of an artificial tooth, comprising: a wide sectional body part having a sectional diameter of 6.5 mm to 8 mm, greater than a sectional diameter of 6 mm of a typical implant body part, whereby the wide sectional body part can be directly implanted into the corresponding alveolar bone without refilling a damaged part with a bone substitutive material when implant surgery ends in failure; and a wide screw thread formed on the outer periphery of the wide sectional body part, the wide screw thread being formed at 1˜1.75 pitch intervals, whereby the wide sectional body part is implanted into the alveolar bone with relatively small resistance.

The wide screw thread includes: a narrow vertical section in parallel with the wide sectional body part and narrower than the wide sectional body part; a lower inclined section inclined from the lower end of the narrow vertical section to the outer periphery of the wide sectional body part; and an upper inclined section inclined from the upper end of the narrow vertical section to the outer periphery of the wide sectional body part and inclined greater than the lower inclined section.

It is preferable that the lower inclined section has an inclination level of 5˜10 degrees based on the outer periphery of the wide sectional body part to compensate compression force applied to the longitudinal direction of the wide sectional body part.

It is preferable that the upper inclined section has an inclination level of 30˜45 degrees based on the outer periphery of the wide sectional body part to allow a smooth implantation of the wide sectional body part.

The wide screw thread further includes upper and lower rounding portions respectively formed at areas where the upper and lower inclined sections are in contact with the wide sectional body part.

The upper rounding portion has a curvature radius greater than that of the lower rounding portion.

It is preferable that a height of the wide sectional body part is equal to or longer than the sectional diameter of the wide sectional body part in order to form a short implantation length.

The wide sectional body part includes: a protrusion formed on the upper portion thereof for supporting an artificial tooth crown, the protrusion having a sectional diameter narrower than that of the wide sectional body part and extending in a longitudinal direction of the wide sectional body part; and, a guide bottom part formed on the lower portion thereof, the guide bottom part not having the wide screw thread from the end portion thereof to a predetermined height for guiding the implantation place of the wide sectional body part.

The guide bottom part includes a curved portion formed on a corner thereof and curved from a side to the lower end thereof.

The guide bottom part includes a number of cutting edge portions formed in a circumferential direction of the wide sectional body part.

The wide sectional body part includes a bevel part formed at the top edge portion thereof for seating and supporting a substitute thereon.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a state where a dental rescue implant according to the present invention is implanted in brief;

FIG. 2 is a perspective view of the implant of the present invention shown in FIG. 1;

FIG. 3 is a sectional view of FIG. 2;

FIGS. 4 and 5 are a plan view and a bottom view of FIG. 2;

FIG. 6a is an enlarged view of an “A” area of FIG. 3;

FIGS. 6b and 6c are views showing distribution of stress and strain through a wide screw thread of FIG. 6a;

FIG. 7a is a view of a conventional V-screw compared with the wide screw thread of the present invention;

FIGS. 7b and 7c are views showing distribution of stress and strain through the V-screw of FIG. 7a;

FIG. 8a is a view of a conventional rectangular screw compared with the wide screw thread of the present invention; and

FIGS. 8b and 8c are views showing distribution of stress and strain through the rectangular screw of FIG. 8a.

### DETAILED DESCRIPTION OF THE PREFERRED EMBODIMENT

Reference will be now made in detail to the preferred embodiment of the present invention with reference to the attached drawings.

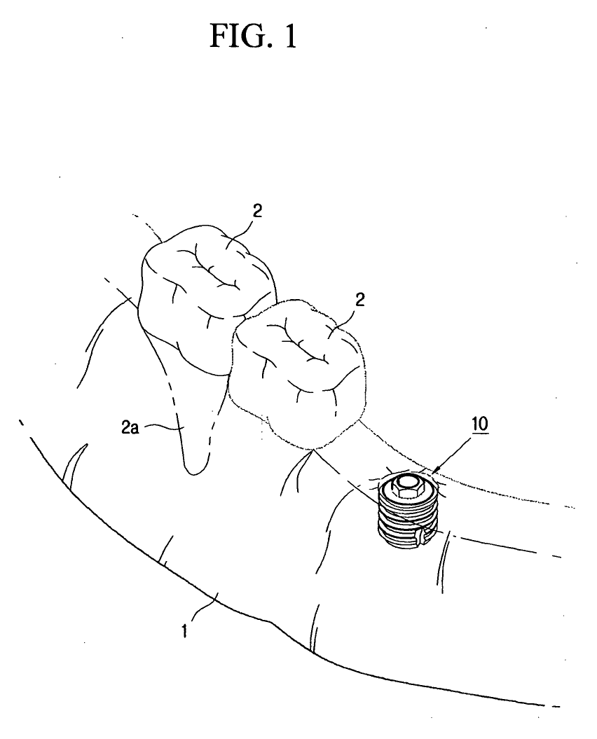

FIG. 1 is a perspective view showing a state where a dental rescue implant according to the present invention is implanted in brief. As shown in the drawing, a number of teeth 2 are arranged on gums 1. The teeth 2 are the first digestive means for finely breaking foods and sending them to the stomach and intestines, and the number of the teeth is generally 28, but it may differ from person to person.

If one tooth 2 of the teeth 2 is lost (loss of molar teeth part), a patient may have a dull sense of taste of foods and feel inconvenience in chewing foods. So, an implant 10 is implanted into the gum 1 of the lost tooth 2 as means for substituting for a root 2a of the tooth 2. The implant 10 is made of titanium which has no rejection to a human body. The implant 10 can be manufactured by the prior art technology.

As described above, conventionally, implants (U.S. Pat. No. 5,702,346) have been implanted into the alveolar bone of the gum 1, where the tooth 2 is lost, as means for substituting the root 2a of the tooth 2. However, if the implant surgery ends in a failure, the bone tissue is damaged, and so, an artificial bone substitute material including calcium and phosphorus ingredients which are similar with ingredients of the bone tissue is transplanted for a predetermined time period in order to restore the damaged bone tissue. After that, when the damaged bone tissue is completely restored, an implant of the same size as the previously implanted implant is generally implanted into the alveolar bone again. However, in this case, it is difficult to operate urgent surgery due to the increase of the surgical operation time period. Furthermore, since the conventional implant is less than 6 mm in sectional diameter of a body part, it is difficult to avoid re-operation if a predetermined time period passes after the implant is implanted.

To solve the above problems, the present invention provides an improved dental rescue implant 10 as described hereinafter.

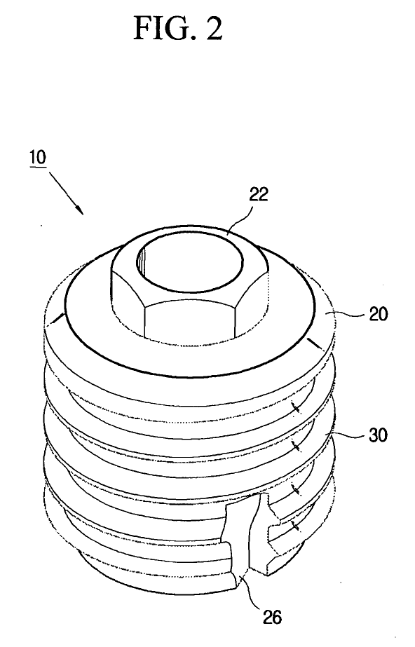

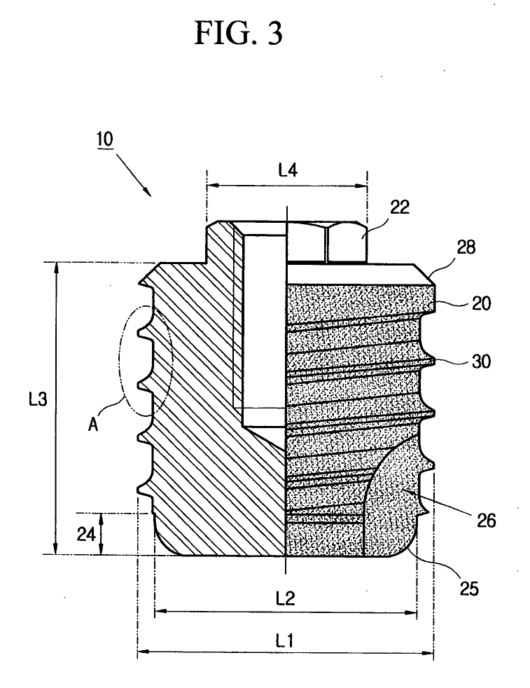

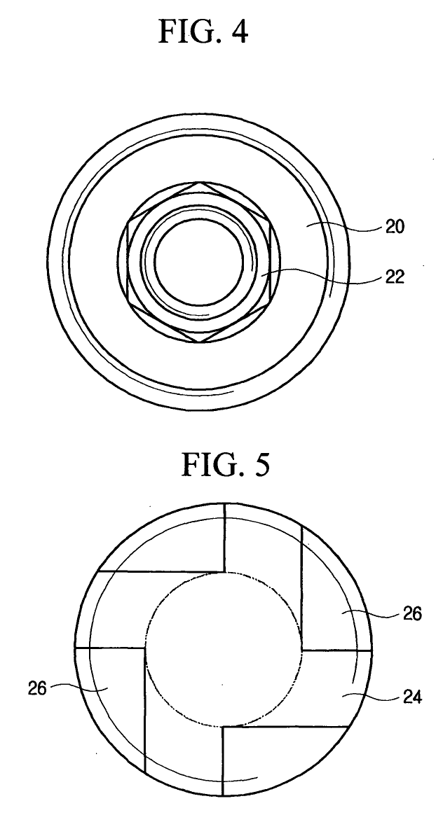

FIG. 2 is a perspective view of the implant of the present invention shown in FIG. 1, FIG. 3 is a sectional view of FIG. 2, and FIGS. 4 and 5 are a plan view and a bottom view of FIG. 2. As shown in the drawings, the dental rescue implant 10 according to the present invention includes a wide sectional body part 20, and a wide screw thread 30 formed on the outer periphery of the wide sectional body part 20.

The wide sectional body part 20 is in a cylindrical form. A sectional diameter (L1) of the wide sectional body part 20 is 6.5 mm to 8 mm which is larger than the maximum sectional diameter (6 mm) of the body part of the conventional implant (U.S. Pat. No. 5,702,346). For example, FIG. 3 shows the wide sectional body part 20 of 7 mm in the sectional diameter (L1). Therefore, the present invention can prevent the ill effect of the conventional implant that an implant of the same size as the previously implanted implant is implanted into the alveolar bone again when the damaged bone tissue is completely restored after the artificial bone substitute material is transplanted for a predetermined time period. That is, the implant according to the present invention can be directly and completely implanted into the corresponding alveolar bone through only once implant surgery even though the damaged portion is not refilled with the bone substitute material when the implant surgery ends in failure.

The sectional diameter (L1) of the wide sectional body part 20 means a length to an exposed end of the wide screw thread 30 formed on the outer periphery of the wide sectional body part 20. Therefore, the sectional diameter (L2) of the wide sectional body part 20 excepting the wide screw thread 30 is relatively short. In FIG. 3, the sectional diameter (L2) is 6.20 mm.

To prevent re-operation, a height (L3) of the wide sectional body part 20 is equal to or longer than the sectional diameter (L1) of the wide sectional body part 20. For instance, in FIG. 3, the height (L3) of the wide sectional body part 20 is 7 mm which is the same length as the sectional diameter (L1) of the wide sectional body part 20. The height (L3) of the wide sectional body part 20 is a distance from the bottom of the wide sectional body part 20 to the top of a bevel part 28 which will be described later.

The wide sectional body part 20 includes a protrusion 22 formed on the upper portion thereof. As shown in FIG. 2, the protrusion 22 has an empty inside and contains an abutment therein for supporting an artificial tooth crown (not shown). The tooth crown is supported on the outer surface of the protrusion 22. The protrusion 22 has a sectional diameter (L4) narrower than the sectional diameter (L1) of the wide sectional body part 20, and extends in a longitudinal direction of the wide sectional body part.

The bevel part 28 for seating and supporting a substitute thereon is formed between the wide sectional body part 20 and the protrusion 22, namely, at the top edge portion of the wide sectional body part 20. The bevel part 28 does not have any curvature and is formed by chamfering.

Meanwhile, as described above, if the sectional diameter (L1) of the wide sectional body part 20 is increased and the height (L3) is reduced, it allows more reliable implant surgery and lowers necessity of re-operation. Moreover, since the height (L3) of the wide sectional body part 20 is reduced, the implantation time period is shortened. However, the implant 10 may be inclined or not be exactly implanted at an early implantation stage due to the wide diameter (L1) and the short implantation length (L3).

To solve the above problem, the wide sectional body part 20 includes a guide bottom part 24 formed on the lower portion of the wide sectional body part 20, on which the wide screw thread 30 is not formed from the end portion thereof to a predetermined height in order to guide the implantation place of the wide sectional body part 20. The guide bottom part 24 includes a curved portion 25 formed on a corner thereof, which is curved from a side to the lower end thereof. As described above, when the sectional diameter (L1) of the wide sectional body part 20 is 7 mm, the curvature radius of the curved portion 25 is about R0.8, and it is good to secure the implantation place at the entrance.

The exact implantation place can be seized through the guide bottom part 24. Additionally, as means for implanting the implant 10 at the early stage, a number of cutting edge portions 26 are formed on the guide bottom part 24 in a circumferential direction of the wide sectional body part 20. The cutting edge portions 26 may be formed by end milling operation.

Since the front edge of the cutting edge portion 26 is sharpened, the implant 10 can be more easily implanted into the alveolar bone at the early implantation stage. Four cutting edge portions 26 are formed in the circumferential direction of the wide sectional body part 20 at regular intervals. However, it is just an example, and so, four or more cutting edge portions 26 can be formed. The cutting edge portions 26 are vertically formed from the lower end of the wide sectional body part 20 to the wide screw thread 30 located at the lower portion of the wide sectional body part 20.

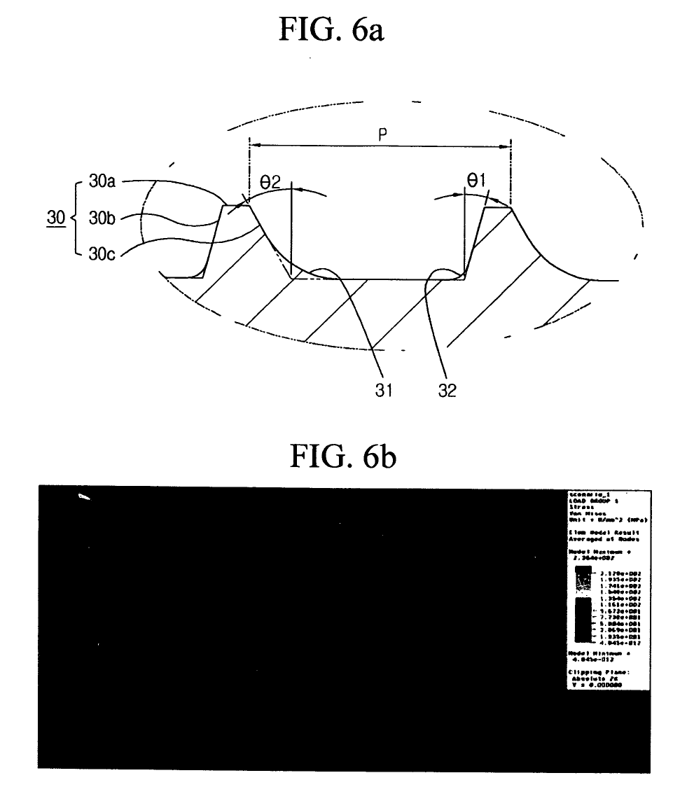

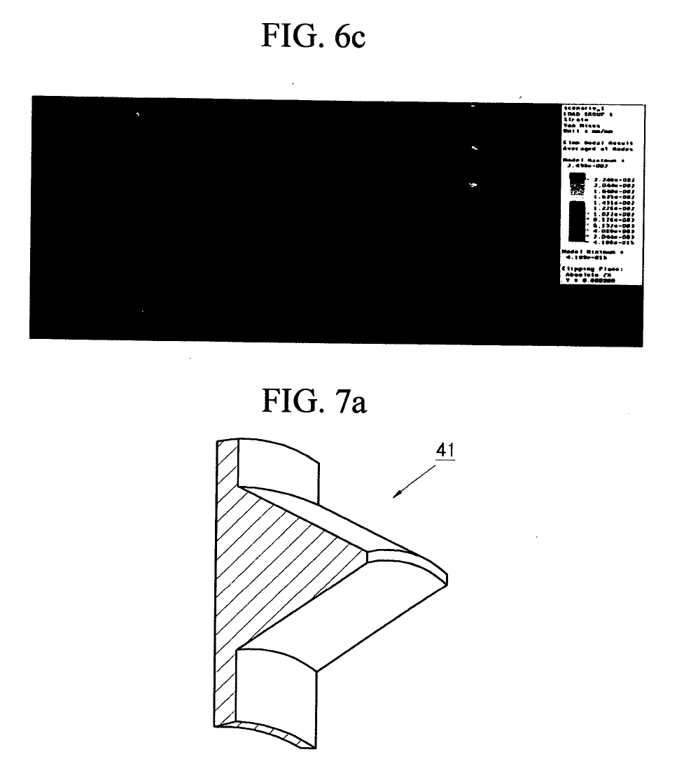

Meanwhile, as means for implanting the wide sectional body part 20 in a screw type, the wide screw thread 30 is formed on the outer periphery of the wide sectional body part 20. The conventional implant (U.S. Pat. No. 5,702,346) also has a screw thread, but the screw thread formed on the outer periphery of the wide sectional body part 20 according to the present invention is relatively widely formed at 1 to 1.75 pitch interval. FIG. 6a shows the wide screw thread 30 of 1.25 pitch interval.

If the wide screw thread 30 is used, the wide sectional body part 20 can be implanted into the alveolar bone at relatively small resistance. That is, the wide sectional body part 20 is implanted into the alveolar bone just by turning it several times, whereby the implant surgery time period is remarkably reduced.

At this time, all conditions are not satisfied only by keeping the wide pitch interval of the wide screw thread 30. That is, various conditions, such as a condition where the implant 10 can be more easily implanted according to types of the wide screw thread 30, distribution of compressed stress transmitted in the longitudinal direction of the implant 10, distribution of strain by shearing force widely spread in an outward radial direction of the wide screw thread 30, and so on, must be satisfied.

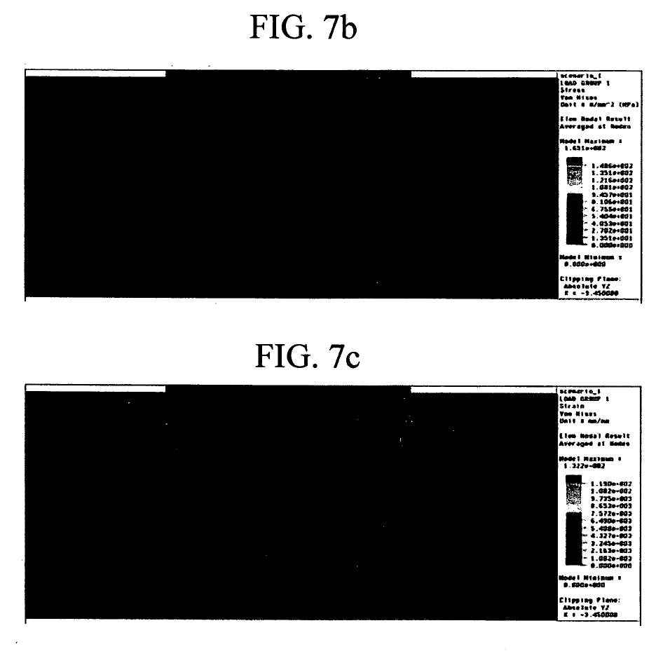

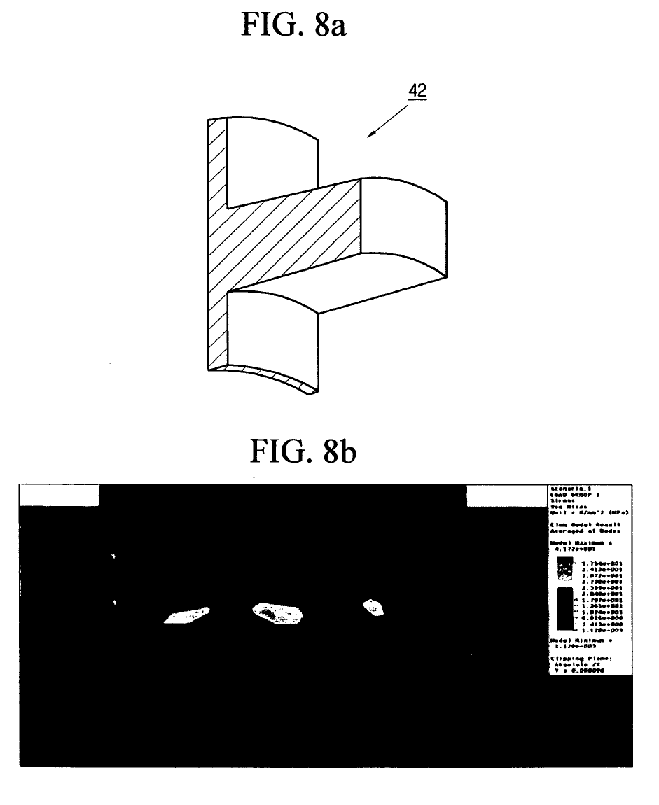

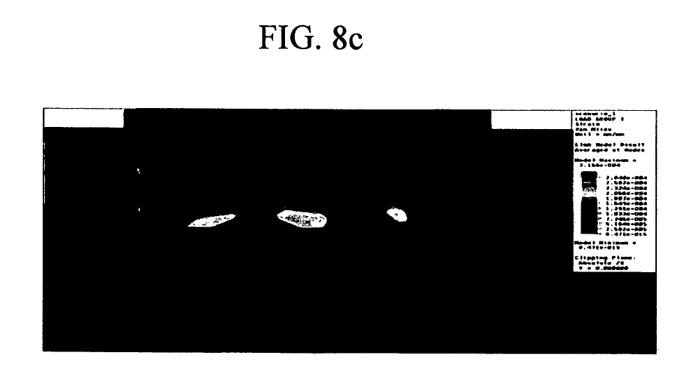

Referring to FIGS. 7a to 8c, the present invention will be described hereinafter.

FIG. 7a is a view of a conventional V-screw compared with the wide screw thread of the present invention. The V-screw 41 shown in FIG. 7a is widely used for a small-sized screw, bolt or nut since it is easily processed, shows a higher precision, and does not get loose after fastening. On the contrary, a rectangular screw 42 shown in FIG. 8a is effectively used to a structure that heavy load is applied or a direction of load is not regular. However, the rectangular screw is difficult in fastening in comparison with the V-screw 41 of FIG. 7a.

Referring to FIGS. 7b and 7c, if an implant having the V-screw 41 is implanted, little stress is generated on the bone. However, as you can see from FIGS. 8b and 8c showing distribution of stress and strain, the rectangular screw 42 of FIG. 8a may cause bone loss due to a long-term integration force since stress and strain are partially concentrated on the lower end of the screw and the base portion of the implant which are in contact with the bone. As a result, the screw thread type of the V-screw 41 of FIG. 7a rather than the rectangular screw 42 of FIG. 8a is good to a place where load is greatly applied.

Meanwhile, as described above, the greatest variables in keeping the alveolar crest and the implanted state of the implant 10 are stress and strain. Relative dangers of different designs must be informed since such factors must be measured and compared for various designs of different implants. Load to the alveolar crest is increased, loss of alveolar crest is also increased. For your reference, the integration force is within a range of 42˜1245N, and strength is 710 N at the molar teeth part, 323-485 N at the canine teeth part, and 150 N at the anterior teeth part.

Under the inside oral condition, three forces of compression force, tension force and shearing force must be applied to the implant 10 by repeated mastication. The bone is the strongest to compression force, 30% weak to tension force, and 65% weak to shearing force. In general, if the surface form of the implant 10 does not have other power for resisting to shearing force, just shearing force is applied to the interface between the bone and the implant 10.

Therefore, an attempt to restrict shearing force is needed, and it can be achieved according to shapes of the screws. That is, a shape of the screw which can allow the implant to continuously function under the circumstance where mastication and intrusive force are applied for a long time is required.

The rectangular screw 42 provides the surface suitable for the intrusive force and compression force, but causes friction force. Friction force is force the worst to the bone. The V-screw 41 causes ten times friction force than the rectangular screw 42. Therefore, the V-screw 41 of FIG. 7a and the rectangular screw 42 of FIG. 8a have lots of merits, but are not suitable for the design of the implant 10 since they cannot satisfy all of the above conditions. That is, the rectangular screw 42 has stronger compression force but is complicated in fastening, and the V-screw 41 has stronger shearing force and is easy to fasten but has compression force weaker than the rectangular force 42.

Therefore, the present invention provides the wide screw thread 30 which has the above merits of the prior art screws and is more improved.

Referring to FIG. 6a, the wide screw thread 30 according to the present invention includes: a narrow vertical section 30a being in parallel with the wide sectional body part 20 and narrower than the wide sectional body part 20; a lower inclined section 30b inclined from the lower end of the narrow vertical section 30a to the outer periphery of the wide sectional body part 20; and an upper inclined section 30c inclined from the upper end of the narrow vertical section 30a to the outer periphery of the wide sectional body part 20 and inclined greater than the lower inclined section 30b. Here, the implant 10 can be easily implanted since the narrow vertical section 30a is sharpened like the V-screw.

The lower inclined section 30b is to compensate compression force applied to the longitudinal direction of the wide sectional body part 20, and has an inclination level (θ1) of 5˜10 degrees based on the outer periphery of the wide sectional body part 20. The lower inclined section 30b is a portion using the merits of the rectangular screw 42.

Meanwhile, the upper inclined section 30c is to allow a smooth implantation of the wide sectional body part 20 and to secure firm fastening force to prevent the implant from being loose after fastening, and has an inclination level (θ2) of 30˜45 degrees based on the outer periphery of the wide sectional body part 20. The upper inclined section 30c is a portion using the merits of the V-screw 41.

In view of the above structure, the wide screw thread 30 according to the present invention takes merits of the V-screw 41 of FIG. 7a and the rectangular screw 42 of FIG. 8a. At this time, the wide screw thread 30 further includes upper and lower rounding portions 31 and 32 respectively formed at areas where the upper and lower inclined sections 30c and 30b are in contact with the wide sectional body part 20. The upper rounding portion 31 is larger in curvature radius than the lower rounding portion 32.

The wide screw thread 30 is formed on the outer periphery of the wide sectional body part 20, and then, the implant 10 is implanted into the alveolar bone. Then, as can be seen from FIGS. 6b and 6c, little stress is applied to the bone, and stress and strain are not partially concentrated on the lower end portion of the screw in contact with the bone and the base of the implant 10. Therefore, the present invention does not cause bone loss due to the long-term integration force.

Furthermore, the wide screw thread 30 according to the present invention forms relatively great shearing force by its structural feature. In a state where the implant 10 stands at right angles, if load is applied inclinedly, stress around the implant 10 is increased, and particularly, around a weak alveolar crest area. However, stress around the alveolar crest area is reduced since load is applied in the longitudinal direction of the implant 10. Moreover, joint pain can be reduced since stress around the abutment is also reduced. Additionally, since the inclination level (θ2) of the upper inclined section 30c of the wide screw thread 30 is greater than the inclination level (θ1) of the lower inclined section 30b, load applied to the interface of the bone is reduced.

By the above structure, when the molar teeth part is lost or the implant surgery ends in a failure by complex factors, the implant 10 of the present invention is arranged on the damaged portion of the gum 1. First, the guide bottom part 24 is placed on the corresponding position to secure an exact implantation place, and then, the implant 10 is turned in a screw type using a tool.

Then, the implant 10 penetrates and is implanted into the alveolar bone while the four cutting edge portions 26 located on the guide bottom part 24 are rotated. At this time, the implant 10 of the present invention can be easily and rapidly implanted with little resistance since the wide sectional body part 20 has the great sectional diameter (L1) and the short height (L3) and includes the wide screw thread 30 formed thereon. After the implantation, the abutment is joined to the implant 10, and then, the abutment is covered with the final substitute, namely, the artificial tooth crown.

As described above, the present invention can be directly implanted into the alveolar bone without refilling the damaged part with the substitutive material even though the molar teeth part is lost or the implant surgery ends in a failure by complex factors, thereby greatly reducing a surgical operation time period and enabling urgent surgery.

In addition, by the improved structure, the implant 10 includes the relatively wide sectional body part 20 and the wide screw thread 30 formed on the outer periphery of the wide sectional body part 20, whereby the surgical operation time period is reduced and re-operation is restricted as much as possible by providing the precise and stable implant surgery.

Moreover, the implant according to the present invention includes the wide sectional body part, which has the sectional diameter wider than that (less than 6 mm) of the conventional implant body and the implantation length shorter than that of the conventional implant body, and the wide screw thread formed on the outer periphery of the wide sectional body part, thereby reducing the surgical operation time period and restricting re-operation as much as possible by providing the precise and stable implant surgery.

Additionally, the present invention includes the guide bottom part, thereby seizing the exact implantation place at the early implantation stage.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A dental rescue implant implanted into an alveolar bone for forming a root of an artificial tooth, comprising:
a wide sectional body part having a sectional diameter ranging from about 6.5 mm to about 8 mm, whereby the wide sectional body part can be implanted directly into the alveolar bone without refilling a damaged part with a bone substitutive material when an implant surgery ends in failure; and
a wide screw thread formed on the outer periphery of the wide sectional body part, the wide screw thread being formed at about 1-1.75 pitch intervals, whereby the wide sectional body part is implanted into the alveolar bone with relatively small resistance.

2. A dental rescue implant according to claim 1, wherein the wide screw thread includes:
a narrow vertical section in parallel with the wide sectional body part and narrower than the wide sectional body part;
a lower inclined section inclined from the lower end of the narrow vertical section to the outer periphery of the wide sectional body part; and
an upper inclined section inclined from the upper end of the narrow vertical section to the outer periphery of the wide sectional body part and inclined greater than the lower inclined section.

3. A dental rescue implant according to claim 2, wherein the lower inclined section has an inclination level of about 5-10 degrees based on the outer periphery of the wide sectional body part to compensate compression force applied to the longitudinal direction of the wide sectional body part.

4. A dental rescue implant according to claim 2, wherein the upper inclined section has an inclination level of about 30-45 degrees based on the outer periphery of the wide sectional body part to allow a smooth implantation of the wide sectional body part.

5. A dental rescue implant according to claim 2, wherein the wide screw thread further includes upper and lower rounding portions respectively formed at areas where the upper and lower inclined sections are in contact with the wide sectional body part.

6. A dental rescue implant according to claim 5, wherein the upper rounding portion has a curvature radius greater than that of the lower rounding portion.

7. A dental rescue implant according to claim 1, wherein a height of the wide sectional body part is equal to or longer than the sectional diameter of the wide sectional body part in order to form a short implantation length.

8. A dental rescue implant according to claim 1, wherein the wide sectional body part includes:
a protrusion formed on the upper portion thereof for supporting an artificial tooth crown, the protrusion having a sectional diameter narrower than that of the wide sectional body part and extending in a longitudinal direction of the wide sectional body part; and,
a guide bottom part formed on the lower portion thereof, the guide bottom part not having the wide screw thread from the end portion thereof to a predetermined height for guiding the implantation place of the wide sectional body part.

9. A dental rescue implant according to claim 8, wherein the guide bottom part includes a curved portion formed on a corner thereof and curved from a side to the lower end thereof.

10. A dental rescue implant according to claim 8, wherein the guide bottom part includes a number of cutting edge portions formed in a circumferential direction of the wide sectional body part.

11. A dental rescue implant according to claim 1, wherein the wide sectional body part includes a bevel part formed at the top edge portion thereof for seating and supporting a substitute thereon.
